(19) United States
(12) Patent Application Publication
(10) Pub. No.: US 2010/0271304 A1
(43) Pub. Date: Oct. 28, 2010

(54) METHOD FOR DETERMINING MOUSE COMMAND ACCORDING TO TRIGGER POINTS

(76) Inventors: Chia-Hsin Yang, Taipei City (TW); Yang-Po Chiu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/753,068

(22) Filed: Apr. 1, 2010

(30) Foreign Application Priority Data
Apr. 24, 2009 (TW) 098113692

(51) Int. Cl. G06F 3/033

(52) U.S. Cl. 345/163

(57) ABSTRACT

The invention discloses a method which may determine a reference point when multiple trigger points are triggered on a detecting device by a user's finger. Whether the reference point corresponds to a left clicking or a right clicking is determined according to the corresponding position relation between the reference point and the trigger points. Operations of a conventional mouse may be performed by the user merely through a touch panel.

### BACKGROUND OF THE INVENTION

1. Field of the Invention

The invention discloses a method for determine a reference point by detecting multiple trigger points on a detecting device and, more particularly, to a method for determining a mouse command via the trigger points.

2. Description of the Related Art

A user usually uses hardware equipment such as a keyboard, a mouse and related operating interfaces to operate a computer, and the mouse is one of the mainstreams. In the market, to facilitate a user's operation, the mouse is developed from a scroll mouse to an optical mouse which detects the operation of the mouse by detecting an optical spot, and then it is further developed to a wireless mouse which detects the operations of the mouse without real cables. However, regardless of the type of the mouse, the user needs to operate the real mouse device to operate the computer. To increase functions and usability, various changes are performed on the construction, shape or weight of the mice. However, no matter how the mice change, manufacturers still need to spend much hardware cost and developing cost to develop the new mice, and a user also needs to spend some time in getting used to the mice with different shapes. In addition, the wireless mouse also needs to be charged, or the battery needs to be charged at regular intervals.

### BRIEF SUMMARY OF THE INVENTION

The invention discloses a method for determining a mouse command by detecting trigger points. The method includes the steps as follows. A reference point is determined according to at least a trigger point. A corresponding position relation between at least a trigger point and the reference point is determined. A mouse command triggered by a user is determined according to the corresponding position relation between at least a trigger point and the reference point.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the detection of the trigger points generated by the user's fingers;

FIG. 2 is a schematic diagram showing the distances between the coordinate of each trigger point and the first coordinate axis;

FIG. 3 to FIG. 8 are schematic diagrams showing that the reference point is determined according to different quantity of the trigger points triggered by the fingers of the user's right hand;

FIG. 9 is a schematic diagram showing the distances between each trigger point on the coordinate system and the second coordinate axis in FIG. 1 and FIG. 2; and

FIG. 10 is a flow chart showing the method for determining the mouse command by detecting the trigger point according to an embodiment of the invention.

### DETAILED DESCRIPTION OF THE EMBODIMENTS

The invention discloses a method for determining a mouse command by detecting trigger points. In the method disclosed in the invention, a user may perform conventional mouse operations without any real mouse device.

In the method disclosed in the invention, when the user's hand touches the touch device, a detecting device may detect the effective trigger points of the user's fingers touching on the touch device, and the detecting device determines the mouse command according to various changes such as the changes of the quantity, the position, the effective triggering time of the effective trigger points.

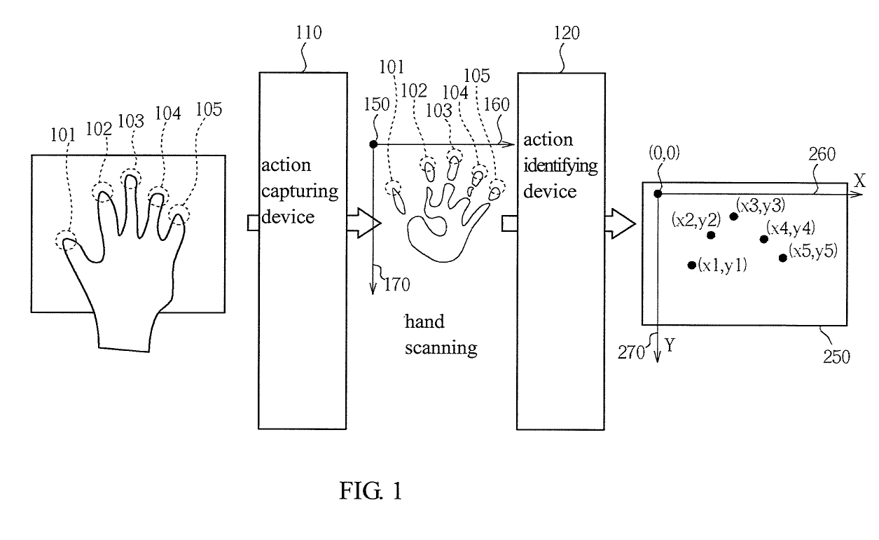

FIG. 1 is a schematic diagram showing that the trigger points are detected in an embodiment of the invention. When the user's hand is put on the detecting device, an action capturing device 110 captures the trigger points of the user's hand to determine effective trigger points 101, 102, 103, 104 and 105. The action capturing device 110 may include an action image detecting device, a touch detecting device and so on. The trigger points 101, 102, 103, 104 and 105 correspond to the effective trigger points generated between the five fingers of the user and the action capturing device 110, just like the general case in which the user may use five fingers to control the mouse to generate the mouse command.

Then, the action identifying device 120 matches the trigger points 101, 102, 103, 104 and 105 with the reference positions of the coordinate system 250 defined in the action identifying device 120. The reference positions are defined as trigger point coordinates (x1, y1), (x2, y2), (x3, y3), (x4, y4), and (x5, y5). In the following description, the trigger point coordinate corresponding to the trigger point 101 is defined as (x1, y1), and other trigger point coordinates corresponding to other trigger points are defined in the same way to facilitate the illustration relating to the trigger points. The coordinate system 250 includes an origin coordinate (0, 0) corresponding to an origin 150 at the up left of the user's hand. A first coordinate axis 260 of the coordinate system 250 corresponds to the horizontal direction of the user's hand, and that is, it corresponds to a first direction 160 started from the origin 150. The first coordinate axis 260 may be considered as the X axis of the coordinate system 250. A second coordinate axis 270 of the coordinate system 250 corresponds to the vertical direction of the user's hand, and that is, it corresponds to a second direction 170 started from the origin 150. The second coordinate axis 270 may be considered as the Y axis of the coordinate system 250.

In an embodiment of the invention, the first direction 160 and the second direction may be orthogonal with each other, and the first coordinate axis 260 also may be orthogonal with the second coordinate axis 270 correspondingly. However, in other embodiments of the invention, the first coordinate axis 260 and the second coordinate axis 270 may not be orthogonal with each other, and the first direction 160 and the second direction 170 also may not be orthogonal with each other. The coordinate system 250 may be defined by the system. The trigger points triggered by the user's hand are certainly located in the quadrant of the coordinate system 250 as shown in FIG. 1 via the coordinate system 250 defined by the system.

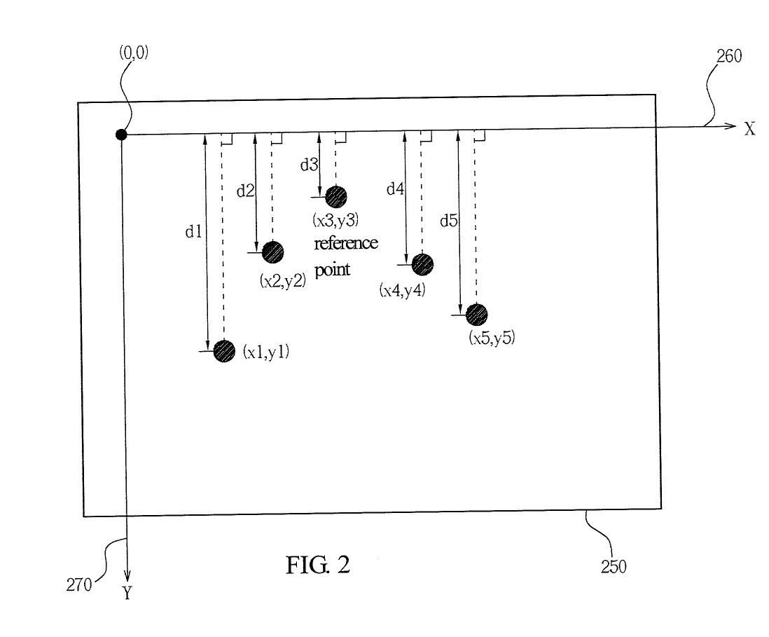

In the method disclosed in the invention, the selection of the reference point may directly affect whether each trigger point triggered by the user corresponds to a left clicking or a right clicking. FIG. 1 and FIG. 2 are schematic diagrams showing the selection of the reference point in an embodiment of the invention. In the embodiment, among the trigger points, one closest to the first coordinate axis 260 is selected as the suitable reference point. FIG. 2 is a schematic diagram showing the relation between distances between the trigger points and the first coordinate axis in FIG. 1. In FIG. 1 and FIG. 2, since the distance d3 between the trigger point coordinate (x3, y3) and the first coordinate axis 260 is shorter than d1, d2, d4 and d5, which are the distances between the other trigger point coordinates of the trigger points and the first coordinate axis 260, the trigger point coordinate (x3, y3) in the coordinate system 250 corresponding to the trigger point 103 generated by the user's middle finger may be selected as the suitable reference point. In the invention, the forefront trigger point of the user's hand is selected as the reference point, and then, whether the trigger point corresponds to the left clicking or the right clicking is determined according to the corresponding relation between the reference point coordinate and other trigger point coordinates, and then the mouse command triggered by the user is determined.

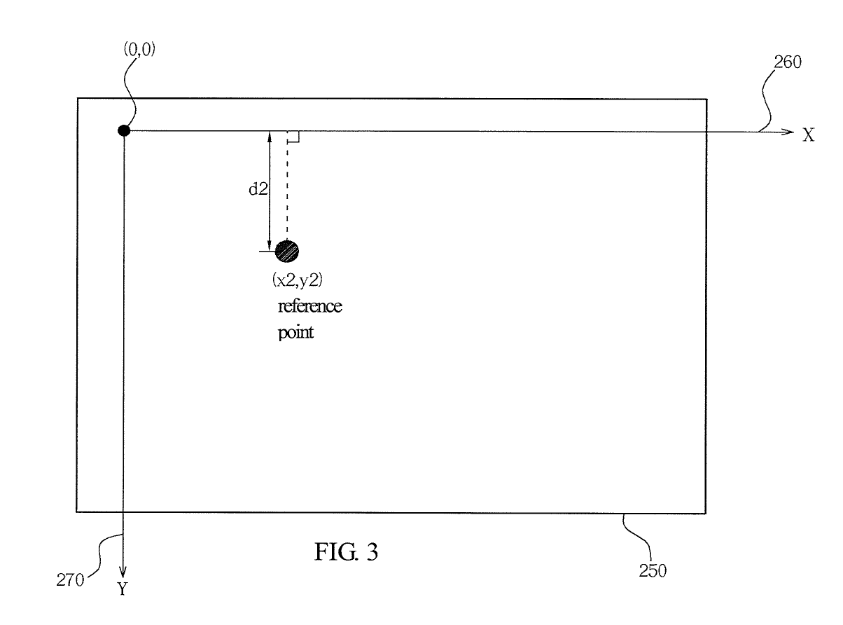

Different users have different habits in using the mouse, and therefore the users may use different quantities of fingers and different combinations to trigger the effective trigger points on the detecting device in different time. In addition, the mouse command triggered by the user should be determined according to the changes, such as the quantity of the trigger points, the effective touch time or the displacement. The change of the quantity of the trigger points affects the determination of the reference point, and the effective touch time and the moving of the trigger points affect the type of the mouse command triggered by the user. The method disclosed in the invention includes the step of determining the change of the quantity of the trigger points. FIG. 3 to FIG. 8 are schematic diagrams showing the determination of the reference point according to different quantities of the trigger points triggered by the user's hand.

In FIG. 3, when the user only uses a forefinger to touch the detecting device, only one trigger point coordinate (x2, y2) is detected in the coordinate system 250. At that moment, the distance d2 between the trigger point coordinate (x2, y2) and the first coordinate axis 260 is the shortest distance between the trigger points and the first coordinate axis 260. Therefore, (x2, y2) is determined to be the coordinate of the reference point, and that is, the trigger point 102 is determined to be the reference point. Similarly, when only one of the trigger points 101, 103, 104 or 105 is detected, the reference point is the detected trigger point in the trigger points 101, 103, 104 and 105.

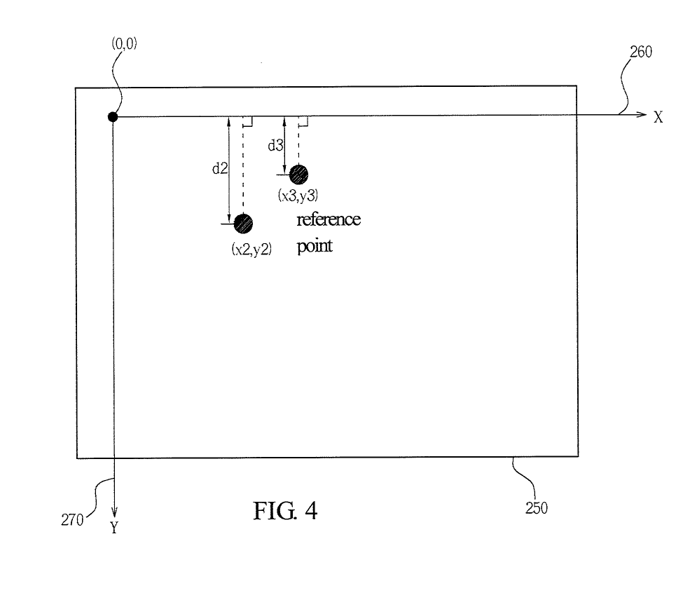

In FIG. 4, when the user triggers the effective trigger points 102 and 103 in the detecting device by the forefinger and the middle finger of the right hand, the coordinate system 250 has the two trigger point coordinates (x2, y2) and (x3, y3). Since the distance d3 between the trigger point coordinate (x3, y3) and the first coordinate axis 260 is shorter than the distance d2 between the trigger point coordinate (x2, y2) and the first coordinate axis 260, (x3, y3) is determined to be the coordinate of the reference point, and that is, the trigger point 103 is determined to be the reference point.

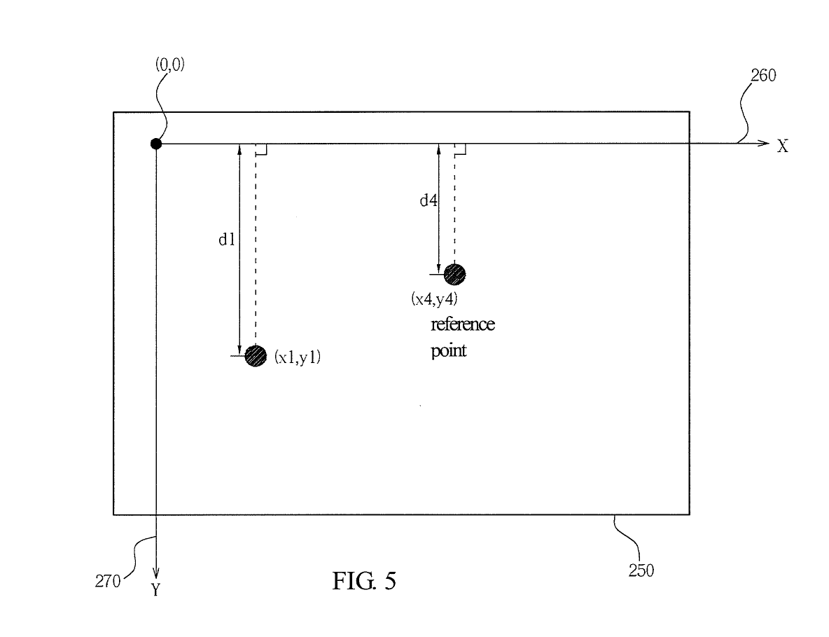

In FIG. 5, the user triggers the effective trigger point 101 and 104 by the thumb and the third finger of the right hand. Since the trigger point coordinate (x4, y4) corresponding to the trigger point 104 is closer to the first coordinate axis 260 in the coordinate system 250, the trigger point 104 is determined to be the reference point.

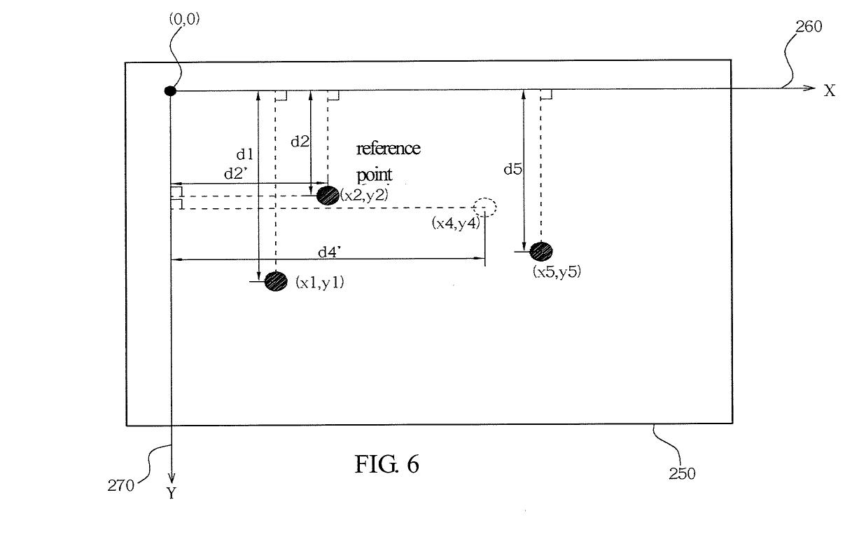

In FIG. 6, if the user uses the thumb, the forefinger and the little finger to trigger the detecting device to obtain the effective trigger points 101, 102 and 105, the corresponding trigger point coordinates (x1, y1), (x2, y2), and (x5, y5) are obtained. At that moment, the distance d2 between the trigger point coordinate (x2, y2) and the first coordinate axis 260 is shorter than the distance dl and the distance d5 between the other two trigger point coordinates and the first coordinate axis 260. Therefore, the trigger point coordinate (x2, y2) is closest to the first coordinate axis 260 in the coordinate system 250, and thus the trigger point 102 is determined to be the reference point.

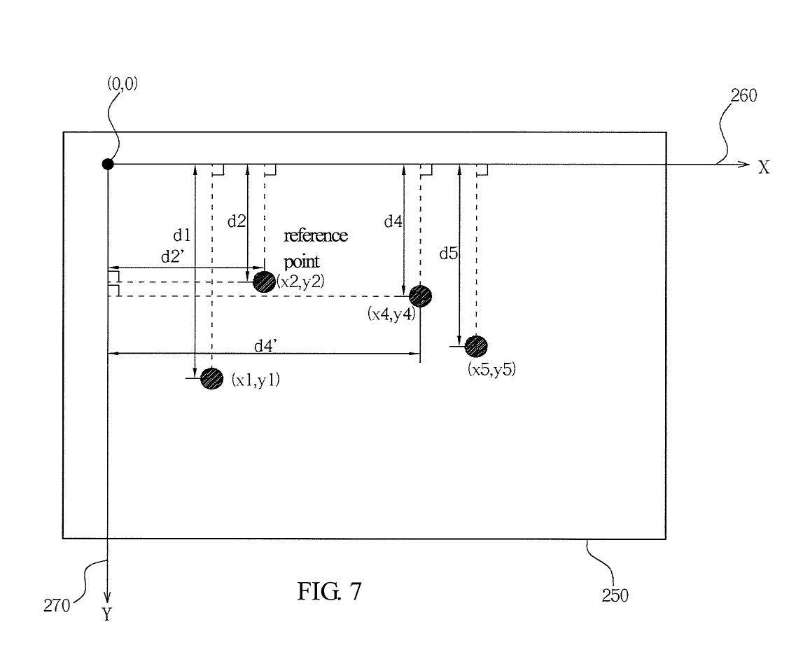

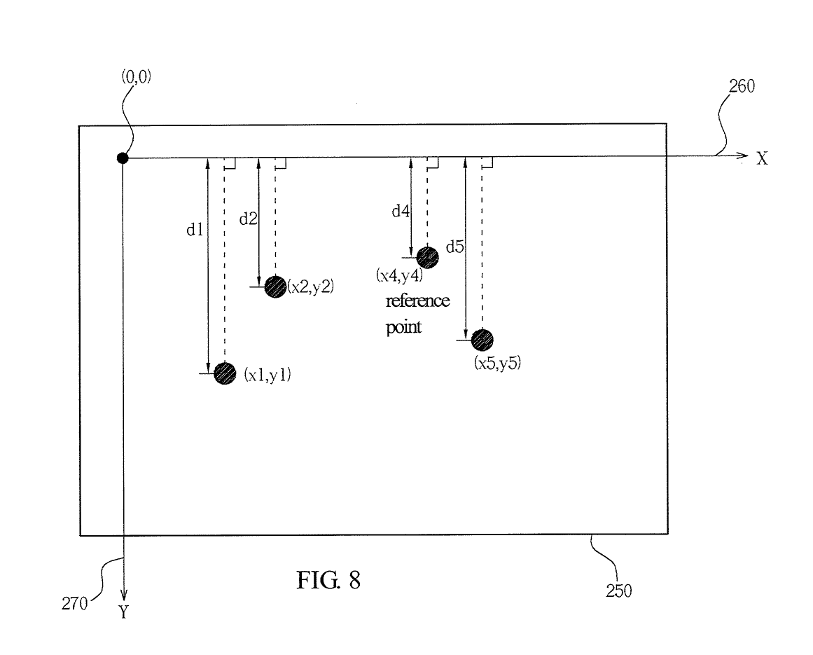

In FIG. 7 and FIG. 8, the user triggers the detecting device by the thumb, the forefinger, the third finger and the little finger of the right hand to obtain the effective trigger points 101, 102, 104 and 105 and the corresponding trigger point coordinates (x1, y1), (x2, y2), (x4, y4) and (x5, y5).

As shown in FIG. 7, since the distance d2 between the trigger point coordinate (x2, y2) and the first coordinate axis 260 is shorter than the distance d4 between the trigger point coordinate (x4, y4) and the first coordinate axis 260, the trigger point 102 is determined to be the reference point rather than the trigger point 104. However, in FIG. 8, the distance d4 between the trigger point coordinate (x4, y4) and the first coordinate axis 260 is shorter than the distance d2 between the trigger point coordinate (x2, y2) and the first coordinate axis 260. Therefore, the trigger point 104 is considered as the reference point, rather than the trigger point 102.

In other words, it is not fixed whether the coordinate of the trigger point 102 or the coordinate of the trigger point 104 is closer to the first coordinate axis 260 in the coordinate system, which depends on the detecting result of the triggered points every time. The reference point is determined according to the detecting result. Similarly, when the user triggers the mouse command with five fingers, the trigger point closest to the first coordinate axis 260 may not the trigger point 103 triggered by the middle finger corresponding to the forefront of the right hand, and it also depends on the distances between each trigger point and the first coordinate axis 260 in the coordinate system 250, and then the reference point is determined.

In the embodiments above, the reference point is determined on the premise that the user uses the right hand. However, the way of detecting the trigger points triggered by the user's left hand is similar, and the reference point also may be determined by the above method.

When the reference point is determined, the corresponding position relation between the reference point and other trigger points which are not determined as the reference point is used to determine whether the trigger point corresponds to the left clicking or the right clicking, and then the mouse command to be executed is determined. Generally, different users have different habits to use left clicking and right clicking to execute different commands. Therefore, in the method of the invention, whether the left clicking or the right clicking is triggered is determined according to the distance between coordinate of the reference point and the second coordinate axis 270 and the distance between the coordinate of the trigger point and the second coordinate axis 270.

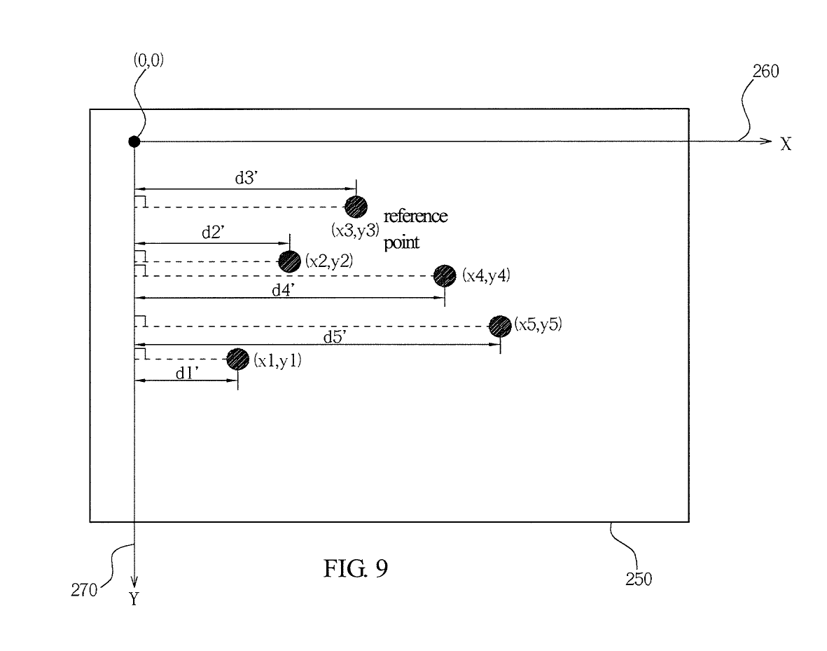

FIG. 9 is a schematic diagram showing the distances between each trigger point and the second coordinate axis 270 in the coordinate system 250 in FIG. 1 and FIG. 2. In FIG. 9, the trigger point 103 is determined to be the reference point. When the states of the trigger point 104 or 105 is changed (for example, the hand contacts the touch device), since the distance d3′ between the trigger point 103 and the second coordinate axis 270 is longer than the distances d4′ which is the distance between the trigger point 104 and the second coordinate axis 270 and the distance d5′ between the trigger point 105 and the second coordinate axis 270, the command generated by the trigger point 104 or 105 may be considered as the mouse command generated by the right clicking. Similarly, when the trigger point 101 or 102 is triggered, since the distance d3′ between the trigger point 103 and the second coordinate axis 270 is longer than the distance d1′ between the trigger point 101 and the second coordinate axis 270 and the distance d2′ between the trigger point 102 and the second coordinate axis 270, the command generated by the trigger point 101 or 102 may be considered as the mouse command generated by the left clicking.

It also may be determined by the system whether the trigger point 103 (namely the reference point) corresponds to the left clicking or the right clicking. In the embodiment of FIG. 9, although it is supposed that the mouse command is generated by the trigger points of the right hand, the method in the embodiment illustrated in FIG. 9 is also adapted to the user using the trigger points of the left hand to generate the mouse command.

Generally, the common mouse command includes the clicking command, and the clicking command includes a right clicking, a left clicking, and a double clicking and so on. In the method disclosed in the invention, an effective clicking command needs to be determined via a critical time for assistance. To the common mouse clicking commands, in a short critical time, any of the user's finger enters the state of contacting a mouse button from the state of not-contacting the mouse button, and then goes back to the state of not-contacting the mouse button (that is, the user's finger is lifted up, clicks the mouse and then leaves the mouse quickly), this may be considered as an effective clicking command. In the method of the invention, when a certain trigger point enters the triggered state from the non-triggered state, and then goes back to the non-triggered state in a critical time, it means that an effective clicking command is generated via the trigger point. The critical time may be one or two seconds determined according to the user's habit, and the period of the critical time also may be set at the user's discretion.

In addition, right clicking or left clicking may be determined according to the step of determining the reference point and the step of determining whether the mouse command is generated by the left clicking or right clicking. As shown in FIG. 6 and FIG. 7, supposing that in the coordinate system 250 and triggered in the critical time, the trigger point 104 enters the triggered state in FIG. 7 from the non-triggered state in

FIG. 6 (the dotted line circle in FIG. 6 represents the non-triggered coordinate (x4, y4) in FIG. 6), and then goes back to the state in FIG. 6. Thus, the trigger point 104 generates an effective touch in the critical time. According to the assumption, since the coordinate of the trigger point (x2, y2) corresponding to the trigger point 102 is determined to be the coordinate of the reference point in FIG. 6 and FIG. 7, and the distance d4′ between the coordinate (x4, y4) corresponding to the trigger point 104 and the second coordinate axis 270 is longer than the distance d2′ between the coordinate (x2, y2) of the trigger point and the second coordinate axis 270 in the coordinate system 250 (namely, the coordinate (x4, y4) of the trigger point is located at the right of the coordinate (x2, y2) of the reference point). Therefore, the effective triggering of the trigger point 104 is determined to be a right clicking command of the mouse. In a similar way, if the effective triggering is generated at the trigger point 101 and the corresponding trigger point coordinate (x1, y1); the triggering is determined to be a left clicking command of the mouse. In addition, if the effective triggering is at the reference point, namely, the effective triggering is generated at the trigger point 102 and the corresponding coordinate (x2, y2) of the trigger point, it is determined according to the built-in setting in the system whether the effective triggering corresponds to the right clicking command or the left clicking command.

In the invention, the critical time is also used as a secondary factor to determine whether the triggering is the double clicking mouse command or not. Generally, the user is used to clicking twice in a critical time with one finger to execute the double clicking command, and to the above coordinate system 250, the same trigger point is effectively triggered twice in the critical time. According to the steps of determining the reference point and determining the left clicking and the right clicking of the reference point in the invention, it is easy to determine whether the double clicking is right double clicking or left double clicking, and the determination of the double clicking is not illustrated herein for a concise purpose.

Additionally, in the method disclosed in the invention, besides the moving or dragging command which may be achieved with two or more fingers (namely two or more trigger points are changed), other commands are usually achieved by merely changing one trigger point. Therefore, when two or more touch points are changed, which is not the moving or dragging command, the commands are considered to be insignificant mouse commands. At that moment, all the trigger points are redetected to correct the quantity and position of the trigger point, and therefore, the insignificant mouse command is avoided.

Although the embodiment only discloses some common mouse commands, other embodiments which determine the corresponding mouse command by determining the left clicking or the right clicking according to the determination of the reference point are also in the scope of the invention.

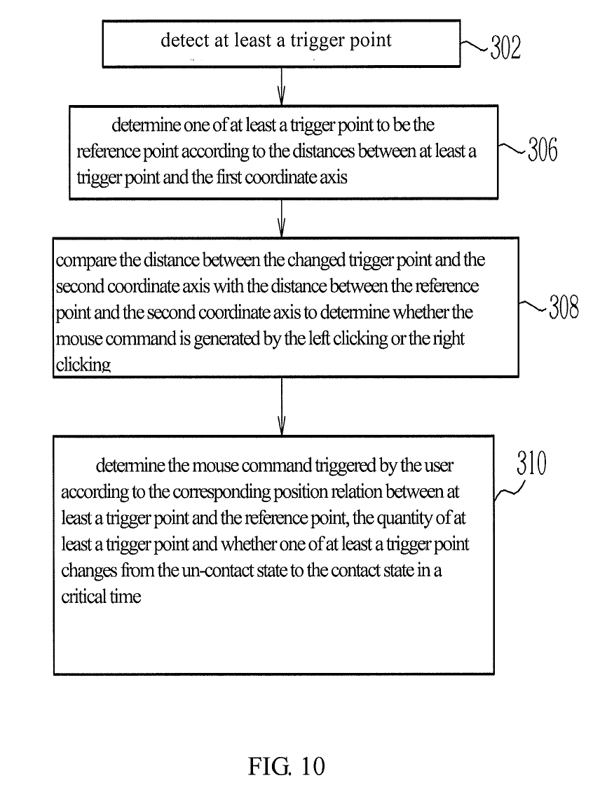

FIG. 10 is a schematic diagram showing the method of determining the mouse command by determining the trigger point according to an embodiment of the invention. As shown in FIG. 10, the method in the invention includes steps as follows.

In step 302, at least a trigger point triggered by the user is detected.

In step 306, one of at least a trigger point is determined to be a reference point according to the distance between at least a trigger point and a first coordinate axis in a coordinate system.

In step S308, the distance between the changed trigger point and a second coordinate axis of the coordinate system and the distance between the reference point and the second coordinate axis is compared, and then whether the triggering corresponds to the command triggered by the left clicking or the right clicking of the mouse command is determined.

In step 310, a mouse command triggered by the user is determined according to the corresponding position relation between at least a trigger point and the reference point, the quantity of at least a trigger point and whether one of at least a trigger point is un-contacted and then contacted in a critical time.

The steps shown in FIG. 10 are the summary of the FIG. 1 to FIG. 9, and the steps in FIG. 10 are not illustrated herein for a concise purpose.

The sequence of the steps shown in FIG. 10 is just a preferred embodiment. Therefore, other embodiments which reasonably arrange or combine the steps in FIG. 10 are also in the scope of the invention.

The invention discloses a method which may determine a reference point according to the trigger point triggered by the user to determine the mouse command corresponding to the triggering. In the method disclosed in the invention, operations of a conventional mouse may be triggered without any real mouse. In the method disclosed in the invention, a reference point is determined by detecting the trigger points on the detecting device triggered by the user's fingers. Then, whether the mouse command is the left clicking or the right clicking is determined according to the corresponding position relation between the reference point and each trigger point, and the type of the mouse command also may be detected. Additionally, the concrete type of the mouse command is further determined according to the change of the triggering position and the effective triggering time. When the trigger point is not touched for a longer time or at least two trigger points are changed at the same time, according to the method of the invention, the current effective trigger point is redetected to avoid the insignificant mouse command.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A method for determining a mouse command by detecting trigger points comprising:
detecting at least a trigger point;
determining a reference point according to at least a trigger point;
determining the corresponding position relation between at least a trigger point and the reference point; and
determining a mouse command according to the corresponding position relation between at least a trigger point and the reference point.

2. The method according to claim 1, wherein the step of detecting at least a trigger point comprises:
detecting at least an effective touch position; and
defining at least an effective touch position as at least a trigger point.

3. The method according to claim 1, wherein the step of determining the reference point according to at least a trigger point comprises:
determining one of at least a trigger point to be the reference point;
wherein at least a trigger point corresponds to at least a trigger point coordinate of a coordinate system defined by system, an origin of the coordinate system corresponds to an up left position, a first coordinate axis of the coordinate system corresponds to the horizontal direction, and a second coordinate axis of the coordinate system corresponds to the vertical direction; and
the distance between the reference point and the first coordinate axis is the shortest among the distances between at least a trigger point and the first coordinate axis.

4. The method according to claim 3, wherein the step of determining the mouse command triggered according to the corresponding position relation between at least a trigger point and the reference point comprises:
comparing the distance between the changed trigger point and the second coordinate axis with the distance between the reference point and the second coordinate axis to determine whether the mouse command is triggered by a left clicking or a right clicking.

5. The method according to claim 4, wherein the step of comparing the distance between the changed trigger point and the second coordinate axis with the distance between the reference point and the second coordinate axis to determine whether the mouse command is triggered by the left clicking or the right clicking comprises:
determining that the mouse command is triggered by the left clicking when the distance between the changed trigger point and the second coordinate axis is less than the distance between the reference point and the second coordinate axis.

6. The method according 4, wherein the step of comparing the distance between the changed trigger point and the second coordinate axis with the distance between the reference point and the second coordinate axis to determine whether the mouse command is triggered by the left clicking or the right clicking comprises:
determining that the mouse command is triggered by the right clicking when the distance between the changed trigger point and the second coordinate axis is larger than the distance between the reference point and the second coordinate axis.
